(19) United States
(12) Patent Application Publication
(10) Pub. No.: US 2016/0248962 A1
(43) Pub. Date: Aug. 25, 2016

(54) Handle-Type Photo Shooting Remote Control Device

(71) Applicant: WINNERS' SUN PLASTIC ELECTRONIC (SHENZHEN) LIMITED COMPANY, Shenzhen, Guangdong (CN)

(72) Inventor: Zhengliang LI, ShangHai (CN)

(73) Assignee: Winners' Sun Plastic & Electronic (Shenzhen) CO. LTD, Shenzhen (CN)

(21) Appl. No.: 14/759,706

(22) PCT Filed: Nov. 12, 2014
(86) PCT No.: PCT/CN2014/090892

§ 371 Date: Jul. 8, 2015

(30) Foreign Application Priority Data
Jan. 24, 2014 (CN) 201420047944.X

(51) Int. Cl. H04N 5/232; H04N 5/225

(52) U.S. Cl. CPC H04N 5/23206; H04N 5/2252

(57) ABSTRACT

The present application relates to a photo shooting remote control device, and particularly to a handle-type photo shooting remote control device, including a handle housing and a wireless remote control. The handle housing includes an accommodation cavity. The front end of the handle housing is provided with a first connector, and the rear end thereof is provided with an opening for the wireless remote control getting in and out of the handle housing, and the wireless remote control is arranged in the accommodation cavity. In the present application, the handle-type photo shooting remote control device is designed to directly or indirectly connect with a camera device to control the camera device, thereby bringing convenience to the user. At the same time, the wireless remote control can be loaded or removed through the opening at the rear end of the handle housing, which facilitates removal of the wireless remote control for data exchange and battery charging operations and also facilitates maintenance and usage of the photo shooting remote control device.

### FIELD OF THE INVENTION

The present application relates to a photo shooting remote control device, and more particularly to a handle-type photo shooting remote control device.

### BACKGROUND

When a user takes a photo, especially when using camera to take a self portrait of himself, which is now called a selfie, the photo image quality may not be good due to various reasons. For example, since the camera is bulky and inconvenient, taking selfies requires the user to hold the camera at arms-length, so the selfie photo turns out to be blurry because the hands shake and tremble. It is impossible to position a smartphone or camera beyond the normal range of the arm. With more people, it is hard to take selfies fitting in everyone's face.

To solve the above problems, users tend to select some auxiliary devices to assist in photo shooting, for example, a portable selfie stick. However, currently, a remote control for shutter release of a mobile phone (camera) on the market is separated from the selfie stick.

So double-handed operation is required when taking pictures. It is very inconvenient and is unfavourable for taking better photos.

### SUMMARY

In order to overcome the aforementioned deficiencies, the present application provides a handle-type photo shooting remote control device, for enhancing convenience in usage for the user.

The handle-type photo shooting remote control device includes a handle housing and a wireless remote control, wherein the handle housing includes an accommodation cavity, a front end of the handle housing is provided with a first connector, a rear end thereof is provided with an opening for the wireless remote control getting in and out of the handle housing, and the wireless remote control is arranged in the accommodation cavity.

In one embodiment, a side wall of the wireless remote control is provided with one or more control buttons.

In one embodiment, an end portion of the wireless remote control is provided with a USB interface.

In one embodiment, a side wall of the handle housing is provided with at least one opening, and the control button corresponds to the opening on the side wall of the handle housing.

In one embodiment, the control button includes a power button, a focusing button, a shutter button and a mode shift button.

In one embodiment, the first connector is provided thereon with a locking device.

In one embodiment, the photo shooting remote control device further includes a telescopic/extendable stick, and the lower end of the telescopic/extendable stick is fixed to the first connector.

In one embodiment, the photo shooting remote control device further includes a telescopic stick, and the lower end of the telescopic stick is fixed to the first connector and is locked with the first connector through the locking device.

In one embodiment, the telescopic/extendable stick includes a plurality of telescoping sections, and a second connector is arranged on the upper end of the telescopic/extendable stick.

In one embodiment, the photo shooting remote control device further includes a clamp device for clamping and holding a camera device, and the clamp device can be connected and fixed to the first connector or the second connector.

In one embodiment, the second connector includes a connecting portion for directly connecting to a camera device or the clamp device.

The beneficial effects of the present application are as follows: compared with the prior art, a handle-type photo shooting remote control device is designed to directly or indirectly connect to a camera device to control the camera device, thereby bringing convenience to the user. At the same time, the wireless remote control can be loaded in or removed from the handle housing through the opening at the rear end of the handle housing, which facilitates removal of the wireless remote control for data exchange and charging operations and also facilitates maintenance and usage of the photo shooting remote control device.

### BRIEF DESCRIPTION OF THE DRAWINGS

The present application will be further described below with reference to the accompanying drawings and embodiments, and wherein:

FIG. 1 is a schematic structural view of a photo shooting remote control device according to one embodiment of the present application;

FIG. 2 is a schematic structural view of a handle housing according to one embodiment of the present application;

FIG. 3 is a schematic structural view of a wireless remote control according to one embodiment of the present application;

FIG. 4 is a schematic structural view of a threaded connector according to one embodiment of the present application;

FIG. 5 is a schematic view of a clamp device according to one embodiment of the present application; and

FIG. 6 is a schematic view of assembly of a photo shooting remote control device according to one embodiment of the present application.

### DETAILED DESCRIPTION

A preferred embodiment of the present application is now described in detail with reference to the accompanying drawings.

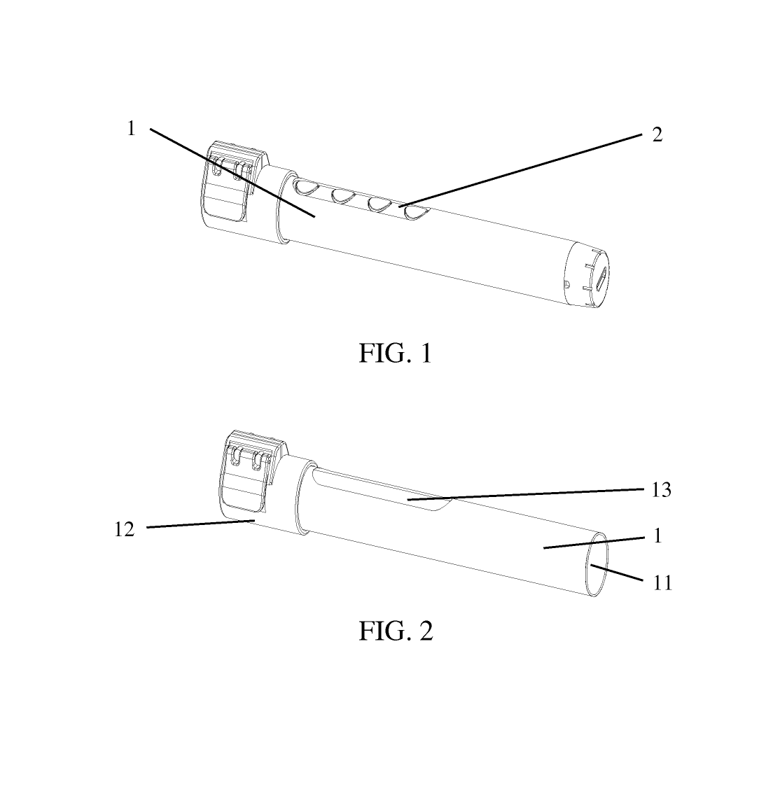

As shown in FIG. 1 to FIG. 3, a preferred embodiment of a photo shooting remote control device is provided. The handle-type photo shooting remote control device in this embodiment includes a handle housing 1 and a wireless remote control 2, the handle housing 1 includes an accommodation cavity, and the wireless remote control 2 is arranged in the accommodation cavity. A front end of the handle housing 1 is provided with a first connector 12, a rear end thereof is provided with an opening 11 for the wireless remote control 2 getting in and out of the handle housing 1. A side wall of the handle housing 1 is provided with at least one opening 13. The first connector 12 may be connected to a photo shooting auxiliary device or a camera device. The accommodation cavity is in communication with the opening 11, and the opening 13 is in communication with the opening 11 through the accommodation cavity. The cross sections of the opening 11 and the accommodation cavity are the same, and the shape of their cross sections may be round or square. A side wall of the wireless remote control 2 is provided with one or more control buttons 21, and an end portion of the wireless remote control 2 is provided with a USB interface 23.

In one embodiment of the present application, the first connector 12 is provided with a locking device.

In one embodiment of the present application, the contact surface of the wireless remote control 2 and the handle housing 1 is provided with a limit structure, wherein a side wall of the wireless remote control 2 is provided with a guide groove, the handle housing 1 is provided with an inward-projecting guide rail matching the guide groove, and the guide groove and the inward-projecting guide rail constitute the limit structure, with the function of preventing the wireless remote control 2 from rotating in the accommodation cavity.

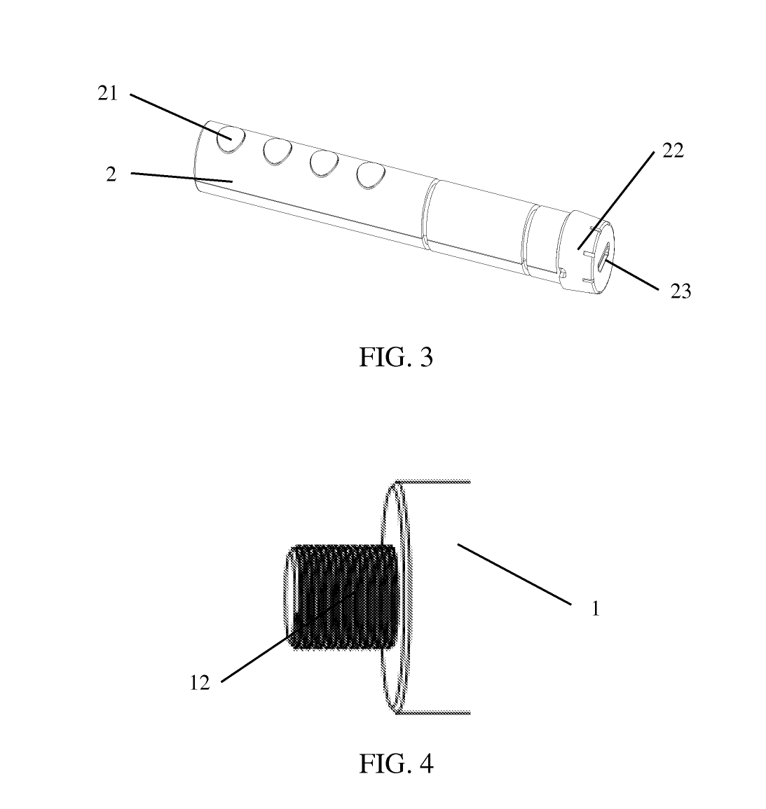

As shown in FIG. 3, in one embodiment of the present application, the USB interface 23 is further connected with a circuit board within the wireless remote control 2. The wireless remote control 2 may conduct data communication with a computer through the USB interface 23, and the USB interface 23 can further provide battery charge through a power module on the circuit board.

As shown in FIG. 3, in this embodiment of the present application, the control buttons 21 corresponds to the opening 13, and the control buttons 21 include at least a power button, a focusing button, a shutter button and a mode shift button. The wireless remote control 2 controls the camera device via wireless connection. The function of the mode shift button is to identify a system of a current camera device and to convert the wireless remote control 2 into a corresponding control mode which matches the system of the current camera device. The system includes Windows systems, Android systems and IOS systems, etc.

As shown in FIG. 3, in one embodiment of the present application, the wireless remote control 2 and camera device are connected via Bluetooth or Wi-Fi.

As shown in FIG. 4, a preferred embodiment of a threaded connector is provided. FIG. 4 is a schematic structural view of a threaded connector according to the present application. The first connector 12 may be a mount adapter (boss) with external threads, and the mount adapter may be connected with a threaded hole on a camera or video camera which is for connecting to a tripod.

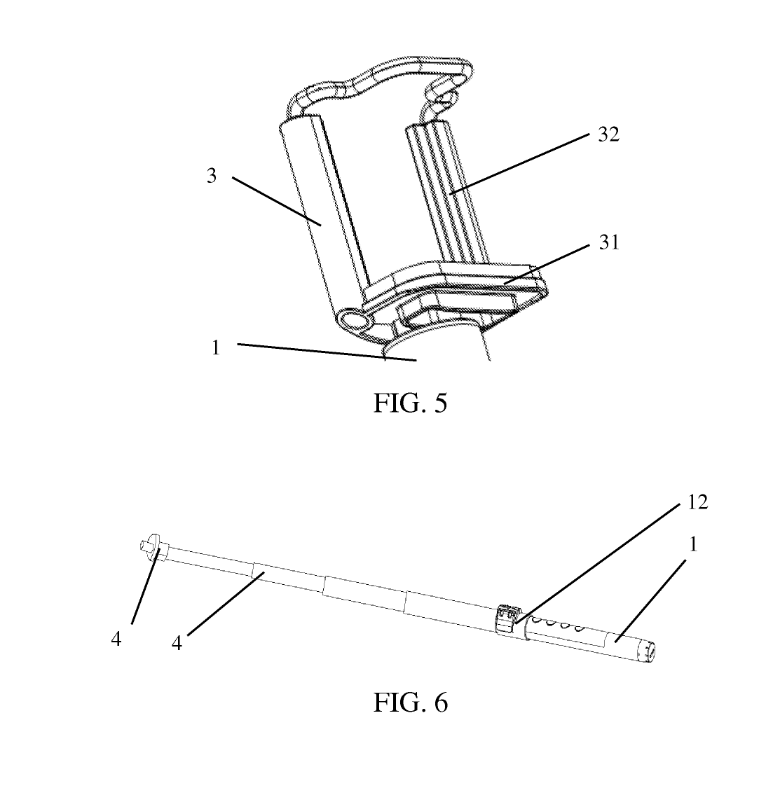

As shown in FIG. 5, a preferred embodiment of a clamp device is provided. FIG. 5 is a schematic view of a clamp device according to the present application. The photo shooting remote control device further includes a clamp device 3 for holding and clamping a camera device. The clamp device 3 includes a fixed mount 32 and a connecting platform 31. The fixed mount 32 can place and hold the camera device. And the connecting platform 31 is connected and fixed to the first connector 12 of the handle housing 1. The camera device may be a smart phone.

As shown in FIG. 6, a preferred embodiment of assembly of a photo shooting remote control device is provided. FIG. 6 is a schematic view of assembly of a photo shooting remote control device according to the present application. The photo shooting remote control device further includes a telescopic/extendable stick 4. The telescopic stick 4 includes a plurality of telescoping sections. A lower end of the telescopic stick 4 is fixed to the first connector 12, and an upper end of the telescopic stick 4 is provided with a second connector 41. The second connector 41 includes a connecting portion for directly connecting to the camera device or the clamp device 3.

As mentioned above, the photo shooting remote control device further includes a telescopic/extendable stick 4. A lower end of the telescopic stick 4 is fixed to the first connector 12. One embodiment is that the lower end of the telescopic stick 4 is locked with the first connector 12 through the locking device (FIG. 1); another embodiment is that the lower end of the telescopic stick 4 is fixed to the first connector 12 through the mount adapter with external threads of the first connector 12 (FIG. 4).

Further, a preferred embodiment of operating a photo shooting remote control device is provided: the handle housing 1 is connected to a photo shooting auxiliary device (e.g. the clamp device 3 and/or the telescopic stick 4) or a camera device (e.g. a camera or a video camera) through the first connector 12; then the wireless remote control 2 is communicated with the camera device; and the wireless remote control 2 is converted into a corresponding control mode matching the system of the current camera device; when shooting a photo, the control button 21 controls the photo shooting of the camera device. Therefore, the photo shooting remote control device of this invention can achieve single-handed operation. It brings convenience to the user. There are two scenarios: the first is that the handle housing 1 is connected to the telescopic stick 4, and the second connector 41 of the telescopic stick 4 is connected to a camera device or the clamp device 3; the second is that the handle housing 1 is directly connected with the clamp device 3, or the camera device.

The above are merely preferred embodiments of the present application, but are not intended to limit the scope of the present application. Any equivalent variations or modifications made according to the claims of the present application should be covered by the present application.

1. A handle-type photo shooting remote control device, comprising:
a handle housing and a wireless remote control, wherein the handle housing comprises an accommodation cavity, a front end of the handle housing is provided with a first connector, a rear end of the handle housing is provided with an opening for the wireless remote control for getting in and out of the handle housing, and the wireless remote control is arranged in the accommodation cavity.

2. The photo shooting remote control device according to claim 1, wherein a side wall of the wireless remote control is provided with one or more control buttons.

3. The photo shooting remote control device according to claim 2, wherein an end portion of the wireless remote control is provided with a USB interface.

4. The photo shooting remote control device according to claim 2, wherein a side wall of the handle housing is provided with at least one opening, and the control button corresponds to the opening.

5. The photo shooting remote control device according to claim 2, wherein the control button comprises a power button, a focusing button, a shutter button and a mode shift button.

6. The photo shooting remote control device according to claim 1, wherein the first connector is provided thereon with a locking device.

7. The photo shooting remote control device according to claim 1, further comprising a telescopic stick, and a lower end of the telescopic stick is fixed to the first connector.

8. The photo shooting remote control device according to claim 6, further comprising a telescopic stick, and wherein the lower end of the telescopic stick is fixed to the first connector and is locked with the first connector through the locking device.

9. The photo shooting remote control device according to claim 8, wherein the telescopic stick comprises a plurality of telescoping sections and a second connector arranged on the upper end of the telescopic stick.

10. The photo shooting remote control device according to claim 9, further comprising a clamp device for clamping and holding a camera device, wherein the clamp device is able to be connected and fixed to the first connector or the second connector.

11. The photo shooting remote control device according to claim 10, wherein the second connector comprises a connecting portion for directly connecting to a camera device or the clamp device.

12. A device for shooting photos by remote control comprising:
a handle housing;
a wireless remote control;
an accommodation cavity in the handle housing;
a front end of the handle housing;
a first connector on the front end of the handle housing; and
a rear end of the handle housing provided with an opening for inserting and removing the wireless remote control from the handle housing;
wherein the wireless remote control is arranged in the accommodation cavity.

13. The device for shooting photos by remote control of claim 12 wherein a side wall of the wireless remote control is provided with one or more control buttons.

14. The device for shooting photos by remote control of claim 13 wherein an end portion of the wireless remote control is provided with a USB interface.

15. The device for shooting photos by remote control of claim 13 wherein a side wall of the handle housing is provided with at least one opening, and the control button corresponds to the opening, and the control button is selected from the group consisting of a power button, a focusing button, a shutter button and a mode shift button.

16. The device for shooting photos by remote control of claim 12 further comprising a telescopic stick, wherein a lower end of the telescopic stick is fixed to the first connector.

17. The device for shooting photos by remote control of claim 12 wherein the first connector is provided thereon with a locking device, further comprising a telescopic stick, and wherein the lower end of the telescopic stick is fixed to the first connector and is locked with the first connector through the locking device.

18. The device for shooting photos by remote control of claim 17 wherein the telescopic stick comprises a plurality of telescoping sections and a second connector arranged on the upper end of the telescopic stick.

19. The device for shooting photos by remote control of claim 18 further comprising a clamp device for clamping and holding a camera device, wherein the clamp device can is able to be connected and fixed to the first connector or the second connector.

20. The device for shooting photos by remote control of claim 19 wherein the second connector comprises a connecting portion for directly connecting to a camera device or to the clamp device.
